(19) United States
(12) Patent Application Publication
(10) Pub. No.: US 2020/0159858 A9
(43) Pub. Date: May 21, 2020

(54) METHOD AND DEVICE FOR GENERATING THERMODYNAMIC DIAGRAM

(71) Applicant: Beijing Gridsum Technology Co., Ltd., Beijing (CN)

(72) Inventors: Duxiu Ouyang, Beijing (CN); Dan Wu, Beijing (CN)

(21) Appl. No.: 15/777,438

(22) PCT Filed: Nov. 16, 2016
(86) PCT No.: PCT/CN2016/106110

§ 371 Date: May 18, 2018

(30) Foreign Application Priority Data
Nov. 20, 2015 (CN) 201510812575.8

(51) Int. Cl. G06F 17/30

(52) U.S. Cl. CPC G06F 17/30864; G06F 17/3089

(57) ABSTRACT

Provided are a method and a device for generating a thermodynamic diagram. The method includes: access data of identical display areas of a plurality of web pages is acquired, wherein the plurality of web pages are identical in page structure, and the identical display areas are areas having identical display content and identical display locations in the plurality of web pages; and the thermodynamic diagram of the identical display areas is generated according to the access data of the identical display areas of the plurality of web pages. The technical problem in the related art of impossibility in monitoring access data of identical display areas of the plurality of web pages via a single thermodynamic diagram is solved.

### TECHNICAL FIELD

The disclosure relates to the field of internet, and more particularly to a method and a device for generating a thermodynamic diagram.

### BACKGROUND

A thermodynamic diagram is used for visually reflecting access situations of a user to web page content via a visual color pattern. Specifically, in the related art, monitoring codes of a thermodynamic diagram are set for a single page, and when a user has access to a set website, data related to user access is recorded via the thermodynamic diagram. However, in the related art, a navigation bar and other areas, except a result area in a page, in a search result page appearing after site search in many websites are not changed, the above-mentioned search result page pertaining to pages identical in page structure.

For example, according to page structure as shown in FIG. 1, display content in both a page area 1 and a page area 3 are fixed, display content in a page area 2 varies due to different search keywords, and pages containing the page structure shown in FIG. 1 are pages identical in page structure.

Because access data of a single page can only be recorded by a single thermodynamic diagram in the related art, all items of data of identical display areas of a plurality of pages identical in page structure cannot be completely monitored, only a representative page in the pages is selected for monitoring, and accordingly, a monitoring result is prone to overgeneralization and lower in accuracy.

Any effective solution has not been proposed yet for the problem in the related art of impossibility in monitoring access data of identical display areas of the plurality of pages via a single thermodynamic diagram.

### SUMMARY

The main objective of the disclosure is to provide a method and a device for generating a thermodynamic diagram, used to solve the problem in the related art of impossibility in monitoring access data of identical display areas of the plurality of pages via a single thermodynamic diagram.

According to an aspect of the disclosure, a method for generating a thermodynamic diagram is provided. The method includes: acquiring access data of identical display areas of a plurality of web pages, wherein the plurality of web pages are identical in page structure, and the identical display areas are areas having identical display content and identical display locations in the plurality of web pages; and generating the thermodynamic diagram of the identical display areas according to the access data of the identical display areas of the plurality of web pages.

According to an example embodiment, wherein acquiring the access data of the identical display areas of the plurality of web pages comprises: acquiring a plurality of web pages having an identical preset quantity of directory hierarchy of a Uniform Resource Locator (URL); acquiring access data of the plurality of web pages having the identical preset quantity of directory hierarchy of the URL; and acquiring the access data of identical display areas of the plurality of web pages from the access data of the plurality of web pages.

According to an example embodiment, wherein acquiring the access data of identical display areas of the plurality of web pages from the access data of the plurality of web pages comprises: acquiring location information of the identical display areas of the plurality of web pages; acquiring location information in the access data of the plurality of web pages; and acquiring the access data of the identical display areas of the plurality of web pages from the access data of the plurality of web pages according to the location information of the identical display areas of the plurality of web pages and the location information in the access data of the plurality of web pages.

According to an example embodiment, wherein generating the thermodynamic diagram of the identical display areas according to the access data of the identical display areas of the plurality of web pages comprises: generating a snapshot of the identical display areas of the plurality of web pages; and generating the thermodynamic diagram of the identical display areas on the snapshot according to the access data of the identical display areas of the plurality of web pages.

According to an example embodiment, wherein the access data comprises at least one of following index parameters: a cursor event, a cursor hovering time and a cursor trajectory.

According to an example embodiment, wherein generating the thermodynamic diagram of the identical display areas on the snapshot according to the access data of the identical display areas of the plurality of web pages comprises: making statistics on an index parameter value of each area on the snapshot according to the access data of the identical display areas of the plurality of web pages; and displaying the index parameter value of each area on the snapshot onto the each area of the snapshot according to a preset rule to obtain the thermodynamic diagram of the identical display areas.

According to another aspect of the disclosure, a device for generating a thermodynamic diagram is provided. The device includes: an acquiring element, configured to acquire access data of identical display areas of a plurality of web pages, wherein the plurality of web pages are identical in page structure, and the identical display areas are areas having identical display content and identical display locations in the plurality of web pages; and a generating element, configured to generate the thermodynamic diagram of the identical display areas according to the access data of the identical display areas of the plurality of web pages.

According to an example embodiment, wherein the acquiring element comprises: a first acquiring component, configured to acquire a plurality of web pages having an identical preset quantity of directory hierarchy of a Uniform Resource Locator (URL); a second acquiring component, configured to acquire access data of the plurality of web pages having the identical preset quantity of directory hierarchy of the URL and a third acquiring component, configured to acquire the access data of identical display areas of the plurality of web pages from the access data of the plurality of web pages.

According to an example embodiment, wherein the third acquiring component comprises: a first acquiring sub-component, configured to acquire location information of the identical display areas of the plurality of web pages; a second acquiring sub-component, configured to acquire location information in the access data of the plurality of web pages and a third acquiring sub-component, configured to acquiring the access data of the identical display areas of the plurality of web pages from the access data of the plurality of web pages according to the location information of the identical display areas of the plurality of web pages and the location information in the access data of the plurality of web pages.

According to an example embodiment, wherein the generating element comprises: a first generating component, configured to generate a snapshot of the identical display areas of the plurality of web pages; and a second generating component, configured to generate the thermodynamic diagram of the identical display areas on the snapshot according to the access data of the identical display areas of the plurality of web pages.

According to an example embodiment, wherein the access data comprises at least one of following index parameters: a cursor event, a cursor hovering time and a cursor trajectory.

According to an example embodiment, wherein the second generating component comprises: a statistic sub-component, configured to make statistics on an index parameter value of each area on the snapshot according to the access data of the identical display areas of the plurality of web pages; and a displaying sub-component, configured to display the index parameter value of each area on the snapshot onto the each area of the snapshot according to a preset rule to obtain the thermodynamic diagram of the identical display areas.

In the embodiment of the present disclosure, access data of identical display areas of a plurality of web pages is acquired, wherein the plurality of web pages are identical in page structure, and the identical display areas are areas having identical display content and identical display locations in the plurality of web pages; and the thermodynamic diagram of the identical display areas is generated according to the access data of the identical display areas of the plurality of web pages. The disclosure generates a thermodynamic diagram from access data of identical display pages of plurality of web pages identical in page structure jointly, so that identical display areas of the plurality of web pages can be comprehensively monitored, thereby improving the accuracy of a monitoring result, solving the problem in the related art of impossibility in monitoring access data of identical display areas of the plurality of pages via a single thermodynamic diagram, and achieving the effect of comprehensively monitoring access data of identical display areas of the plurality of pages via a single thermodynamic diagram.

### BRIEF DESCRIPTION OF THE DRAWINGS

The drawings, forming a part of the disclosure, are used to provide further understanding for the disclosure. The schematic embodiments and illustrations of the disclosure are used to explain the disclosure, and do not form improper limits to the disclosure. In the drawings:

FIG. 1 shows schematic diagram of pages identical in page structure in the related art;

FIG. 2 shows flowchart of a method for generating a thermodynamic diagram according to an embodiment of the disclosure; and

FIG. 3 shows schematic diagram of a thermodynamic diagram generating device according to an embodiment of the disclosure.

### DETAILED DESCRIPTION OF THE EMBODIMENTS

It is important to note that embodiments in the disclosure and characteristics in the embodiments may be combined mutually under the condition of no conflicts. The disclosure will be illustrated below with reference to the drawings and in conjunction with the embodiments in detail.

In order to make those skilled in the art better understand the solutions of the disclosure, the technical solutions in the embodiments of the disclosure will be clearly and completely described below in conjunction with the drawings in the embodiments of the disclosure. Obviously, the described embodiments are only a part of the embodiments of the disclosure, not all of the embodiments. On the basis of the embodiments of the disclosure, all other embodiments obtained on the premise of no creative work of those skilled in the art shall fall within the scope of protection of the disclosure.

It is important to note that the description and claims of the disclosure and terms “first”, “second” and the like in the drawings are used to distinguish similar objects, and do not need to describe a specific sequence or a precedence order. It will be appreciated that data used in such a way may be exchanged under appropriate conditions, in order that the embodiments of the disclosure described here can be implemented in a sequence except sequences graphically shown or described here. In addition, terms “include” and “have” and any inflexions thereof are intended to cover non-exclusive inclusions. For example, processes, methods, systems, products or equipment containing a series of steps or units do not need to clearly show those steps or units, and may include other inherent steps or units of these processes, methods, products or equipment, which are not clearly shown instead.

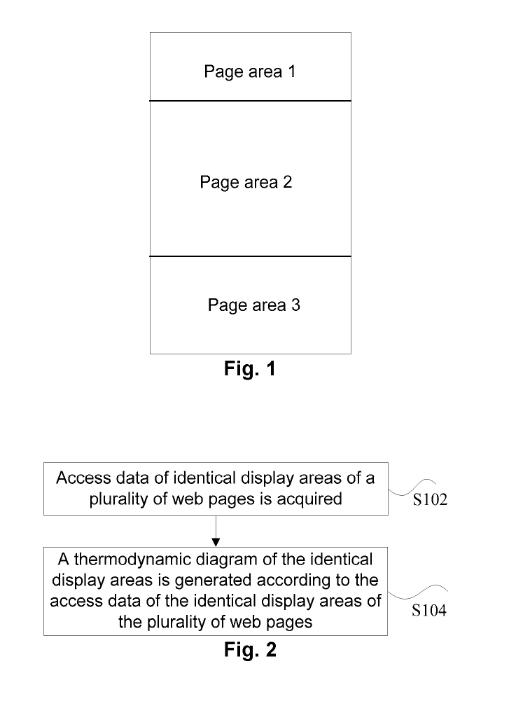

According to the embodiments of the disclosure, a method for generating a thermodynamic diagram is provided. FIG. 2 is a flowchart of a method for generating a thermodynamic diagram according to an embodiment of the disclosure. As shown in FIG. 2, the method includes step S102 to step S104 as follows.

In step S102, access data of identical display areas of a plurality of web pages is acquired, wherein the plurality of web pages are identical in page structure, and the identical display areas are areas having identical display content and identical display locations in the plurality of web pages.

Specifically, the operation is illustrated with a tourism website. When different countries are searched in the tourism website, corresponding search result pages will appear. However, only part of display areas of these search result pages display different content along with different countries, and other display areas are not changed. For example, when Shanghai, China is searched, a display content of a result area of a current search result page corresponds to Shanghai, China, but a navigation bar and a bottom area are not changed; and when Paris, France is searched, a display content of a result area of a current search result page corresponds to Paris, France, and likewise, the navigation bar and the bottom area are not changed. The above-mentioned search result pages are web pages identical in page structure, and the display areas such as the navigation bars and the bottom areas are identical display areas of the multiple search result pages.

The embodiment of the disclosure may acquire access data of identical display areas of all web pages identical in page structure in a target website, wherein the target website is a website needing to monitor access data, and the access data may include a click position, a cursor hovering time, a cursor trajectory and the like. If there are ten web pages with the identical page structure in a target website A, access data of identical display areas of the ten web pages is acquired.

Alternatively, the step of acquiring access data of identical display areas of a plurality of web pages includes: a plurality of web pages having an identical preset quantity of directory hierarchy of a Uniform Resource Locator (URL) is acquire; access data of the plurality of web pages having the identical preset quantity of directory hierarchy of the URL is acquired; and the access data of identical display areas of the plurality of web pages from the access data of the plurality of web pages is acquire.

A URL usually contains multiple directory hierarchies. If a URL is http://lvyou.ctrip.com/place/yinggou20354.htmlt, the URL contains three directory hierarchies. Specifically, a preset directory hierarchy quantity needs to be set according to practical situations. For example, in some websites, when the first two directory hierarchies of a URL are identical, the page structure of web pages are the same, and in this case, it is only necessary to set a preset quantity of directory hierarchies as the first two directory hierarchies; and in some other websites, when the first three directory hierarchies of a URL are identical, the page structure of web pages are the same, and in this case, it is necessary to set a preset quantity of directory hierarchies as the first three directory hierarchies.

For example, URLs of a plurality of web pages, identical in page structure, of a certain tourism website are as follows:

http://lvyou.ctrip.com/place/yingguo20354.htmlt

http://lvyou.ctrip.com/place/xila100036.htmlt

http://lvyou.ctrip.com/place/meiguo10382.htmlt

http://lvyou.ctrip.com/place/hanguo150620.htmlt

In this case, a preset quantity of directory hierarchies may be set as the first two directory hierarchies, that is, web pages of which the URLs contain http://lvyou.ctrip.com/place are web pages identical in page structure. Specifically, the embodiment of the disclosure may set http://lvyou.ctrip.com/place as a rule, and collect access data of all web pages satisfying this rule in the website, so as to obtain access data of plurality of web pages identical in page structure.

In the embodiment of the disclosure, after the access data of the plurality of web pages identical in page structure is obtained, access data of identical display areas of the plurality of web pages may be acquired from the access data of the plurality of web pages. Alternatively, the step of acquiring the access data of identical display areas of the plurality of web pages from the access data of the plurality of web pages comprises: location information of the identical display areas of the plurality of web pages is acquired; location information in the access data of the plurality of web pages is acquired and the access data of the identical display areas of the plurality of web pages from the access data of the plurality of web pages is acquired according to the location information of the identical display areas of the plurality of web pages and the location information in the access data of the plurality of web pages.

Specifically, if identical display areas of the plurality of web pages are rectangular, square or the like, location information of the identical display areas may be corner coordinates of the identical display areas. If the identical display areas of the plurality of web pages are other shapes, location information of the identical display areas may be a coordinate set of all pixels in the identical display areas. The location information in the access data of the embodiment of the disclosure may be a click coordinate, a cursor hovering coordinate or the like. The operation will be illustrated by taking location information in access data as a click coordinate and location information of identical display areas as a coordinate set of all pixels in the identical display areas as follows.

After a click coordinate in access data is acquired, it is judged whether the click coordinate pertains to a coordinate set of all pixels in identical display areas. If the click coordinate pertains to the coordinate set of all the pixels in the identical display areas, it means that access data to which the click coordinate pertains is access data in the identical display areas. If the click coordinate does not pertain to the coordinate set of all the pixels in the identical display areas, it is shown that access data to which the click coordinate pertains is not access data in the identical display areas. The embodiment of the disclosure may obtain access data of identical display areas by comparing a click coordinate in all items of access data with coordinates of all pixels in identical display areas.

It is important to note that in the embodiment of the disclosure, it may be judged whether collected access data pertains to identical display areas when collecting the access data from a web page side; if it is determined that currently collected access data pertains to the identical display areas, the access data is stored in a first storage area or sent to a background server for generating a thermodynamic diagram; and if it is determined that currently collected access data does not pertain to the identical display areas, the access data is discarded or stored in a second storage area, wherein the first storage area and the second storage area are different storage areas.

In step S104, a thermodynamic diagram of the identical display areas is generated according to the access data of the identical display areas of the plurality of web pages.

The disclosure comprises: access data of identical display areas of a plurality of web pages is acquired, wherein the plurality of web pages are identical in page structure, and the identical display areas are areas having identical display content and identical display locations in the plurality of web pages; and the thermodynamic diagram of the identical display areas is generated according to the access data of the identical display areas of the plurality of web pages. The disclosure generates a thermodynamic diagram from access data of identical display pages of plurality of web pages identical in page structure jointly, so that identical display areas of the plurality of web pages can be comprehensively monitored, thereby improving the accuracy of a monitoring result, solving the problem in the related art of impossibility in monitoring access data of identical display areas of the plurality of pages via a single thermodynamic diagram, and achieving the effect of comprehensively monitoring access data of identical display areas of the plurality of pages via a single thermodynamic diagram.

In the embodiment of the disclosure, after the access data of the identical display areas of the plurality of web pages is acquired, the thermodynamic diagram corresponding to the identical display areas may be generated. Alternatively, the step of generating the thermodynamic diagram of the identical display areas according to the access data of the identical display areas of the plurality of web pages comprises: a snapshot of the identical display areas of the plurality of web pages is generated; and the thermodynamic diagram of the identical display areas on the snapshot is generated according to the access data of the identical display areas of the plurality of web pages.

Specifically, the snapshot of the identical display areas in the embodiment of the disclosure is a screenshot of the identical display areas of the plurality of web pages. After the screenshot of the identical display areas is obtained, the screenshot of the identical display areas may be colored based on the access data of the identical display areas of the plurality of web pages to generate a thermodynamic diagram of the identical display areas.

Alternatively, the access data comprises at least one of following index parameters: a cursor event, a cursor hovering time and a cursor trajectory. The step of generating the thermodynamic diagram of the identical display areas on the snapshot according to the access data of the identical display areas of the plurality of web pages comprises: statistics on an index parameter value of each area on the snapshot is maked according to the access data of the identical display areas of the plurality of web pages; and the index parameter value of each area on the snapshot onto the each area of the snapshot is displayed according to a preset rule to obtain the thermodynamic diagram of the identical display areas.

The cursor event in the embodiment of the disclosure may be a click event, the cursor hovering time refers to a hovering time of a cursor at a certain location or in a certain area, and the cursor trajectory refers to a moving trajectory of the cursor. A preset rule in the embodiment of the disclosure refers to a preset coloring rule. For example, the snapshot is colored with different color depths according to the size of an index parameter value, and usually, as the index parameter value is larger, the color is deeper.

Specifically, when a thermodynamic diagram of identical display areas is drawn, the thermodynamic diagram may be drawn based on a single index parameter such as based on a click event, or based on a cursor hovering time or based on a cursor trajectory, or the thermodynamic diagram may be drawn jointly in conjunction with multiple index parameters such as in conjunction with a click event and a cursor trajectory. The operation will be illustrated by drawing a thermodynamic diagram of identical display areas based on a click event as follows.

Firstly, the clicks of each area in identical display areas is calculated according to access data of the identical display areas of the plurality of web pages, and secondly, a snapshot is colored according to the click count of each area in the identical display areas in accordance with a preset rule, so as to obtain a thermodynamic diagram of the identical display areas.

It is important to note that if multiple identical display areas are present in the plurality of web pages identical in page structure, a thermodynamic diagram may be generated for the display areas respectively according to the above-mentioned method.

The embodiment of the disclosure will be illustrated with an example as follows.

In step S202, all pages identical in page structure are judged based on the rule, wherein the rule may be that the parts of file name before the directory hierarchy of a URL are identical while only other parts of file names after the directory hierarchy are different.

For example, URLs of the plurality of web pages, identical in page structure, under the same website are as follows.

http://lvyou.ctrip.com/place/yingguo20354.htmlt

http://lvyou.ctrip.com/place/xila100036.htmlt

The rule may be set as http://lvyou.ctrip.com/place, and access data of all web pages satisfying this rule is collected, wherein all the web pages satisfying this rule are identical in page structure.

In step S204, a snapshot of identical display areas of the above-mentioned web pages is generated.

Specifically, the structure of the above-mentioned web pages may be judged to determine an area (namely identical display areas) needing to be monitored by a thermodynamic diagram, and the area needing to be monitored is set as a snapshot.

In step S206, data of all identical display areas is displayed on the snapshot.

After the snapshot of the identical display areas is generated, location information of the identical display areas may be acquired, access data of the identical display areas is acquired according to the location information of the identical display areas, and a thermodynamic diagram is further generated on the snapshot based on the access data of the identical display areas so as to display the access data of the identical display areas.

From the above description, it can be seen that the embodiment of the disclosure may monitor identical display areas of the plurality of web pages identical in page structure to observe influence of access data of the identical display areas on a user. The embodiment of the disclosure comprehensively monitors the access data of the identical display areas by monitoring the plurality of web pages in batches, so that overgeneralization is avoided, thereby improving the accuracy of a monitoring result.

It is important to note that the steps shown in the flowchart of the drawings may be executed in a computer system including, for example, a set of computer-executable instructions. Moreover, although a logic sequence is shown in the flowchart, the shown or described steps may be executed in a sequence different from the sequence here under certain conditions.

According to another aspect of the embodiment of the disclosure, a thermodynamic diagram generating device is provided. The thermodynamic diagram generating device may be configured to execute the thermodynamic diagram generating method of the embodiment of the disclosure. The thermodynamic diagram generating method of the embodiment of the disclosure may also be executed by the thermodynamic diagram generating device of the embodiment of the disclosure.

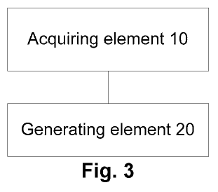

FIG. 3 is a schematic diagram of a thermodynamic diagram generating device according to an embodiment of the disclosure. As shown in FIG. 3, the device includes: an acquiring element 10 and a generating element 20.

The acquiring element 10 is configured to acquire access data of identical display areas of a plurality of web pages, wherein the plurality of web pages are identical in page structure, and the identical display areas are areas having identical display content and identical display locations in the plurality of web pages.

Alternatively, the acquiring element 10 includes: a first acquiring component, configured to acquire a plurality of web pages having an identical preset quantity of directory hierarchy of a Uniform Resource Locator (URL); a second acquiring component, configured to acquire access data of the plurality of web pages having the identical preset quantity of directory hierarchy of the URL and a third acquiring component, configured to acquire the access data of identical display areas of the plurality of web pages from the access data of the plurality of web pages.

Alternatively, the third acquiring component includes: a first acquiring sub-component, configured to acquire location information of the identical display areas of the plurality of web pages a second acquiring sub-component, configured to acquire location information in the access data of the plurality of web pages and a third acquiring sub-component, configured to acquiring the access data of the identical display areas of the plurality of web pages from the access data of the plurality of web pages according to the location information of the identical display areas of the plurality of web pages and the location information in the access data of the plurality of web pages.

The generating element 20 is configured to generate the thermodynamic diagram of the identical display areas according to the access data of the identical display areas of the plurality of web pages.

In the embodiment of the disclosure, an acquiring element 10 acquires access data of identical display areas of a plurality of web pages, wherein the plurality of web pages are identical in page structure, and the identical display areas are areas having identical display content and identical display locations in the plurality of web pages; and a generating element 20 generates the thermodynamic diagram of the identical display areas according to the access data of the identical display areas of the plurality of web pages. The disclosure generates a thermodynamic diagram from access data of identical display pages of plurality of web pages identical in page structure jointly, so that identical display areas of the plurality of web pages can be comprehensively monitored, thereby improving the accuracy of a monitoring result, solving the problem in the related art of impossibility in monitoring access data of identical display areas of the plurality of pages via a single thermodynamic diagram, and achieving the effect of comprehensively monitoring access data of identical display areas of the plurality of pages via a single thermodynamic diagram.

Here, it is important to note that the acquiring element 10, the generating element 20, the first acquiring component, the second acquiring component, the third acquiring component, the first acquiring sub-component, the second acquiring sub-component and the third acquiring sub-component may be operated in a computer terminal by serving as a part of the device, functions implemented by the above-mentioned modules may be executed by means of a processor in the computer terminal, and the computer terminal may be terminal equipment such as a smart phone (Android phone, iOS phone or the like), a tablet computer, a palmtop, Mobile Internet Devices (MID), a PAD, and so on.

Alternatively, the generating element 20 includes: a first generating component, configured to generate a snapshot of the identical display areas of the plurality of web pages; and a second generating component, configured to generate the thermodynamic diagram of the identical display areas on the snapshot according to the access data of the identical display areas of the plurality of web pages.

Here, it is important to note that the first generating component and the second generating component may be operated in a computer terminal by serving as a part of the device, functions implemented by the above-mentioned modules may be executed by means of a processor in the computer terminal, and the computer terminal may be terminal equipment such as a smart phone (Android phone, iOS phone or the like), a tablet computer, a palmtop, an MID, a PAD, and so on.

Alternatively, the access data includes at least one of the following index parameters: a cursor event, a cursor hovering time and a cursor trajectory. The second generating component includes: a statistic sub-component, configured to make statistics on index parameter values of each area on the snapshot according to the access data of the identical display areas of the plurality of web pages; and a displaying sub-component, configured to display the index parameter values of each area on the snapshot onto each area of the snapshot according to a preset rule to obtain the thermodynamic diagram of the identical display areas.

Here, it is important to note that the statistic sub-component and the displaying sub-component may be operated in a computer terminal by serving as a part of the device, functions implemented by the above-mentioned modules may be executed by means of a processor in the computer terminal, and the computer terminal may be terminal equipment such as a smart phone (Android phone, iOS phone or the like), a tablet computer, a palmtop, an MID and a PAD.

The thermodynamic diagram generating device includes a processor and a memory. The acquiring element, the generating element and the like are stored in the memory as program units respectively, and the processor executes the program units stored in the memory to achieve corresponding functions.

The processor contains a kernel, which calls a corresponding program unit from the memory. There may be one or more kernels, and access data of identical display areas of the plurality of web pages identical in page structure is monitored by adjusting kernel parameters.

The memory may include a volatile memory, a Random Access Memory (RAM) and/or a non-volatile memory in a computer-readable medium such as a Read-Only Memory (ROM) or a flash RAM. And the memory includes at least one storage chip.

Here, it is important to note that each function unit provided in the embodiment of the disclosure may be operated in a mobile terminal, a computer terminal or a similar operating device, or may be stored as a part of a storage medium.

Hereupon, the embodiment of the present disclosure may provide a computer terminal, and the computer terminal may be any one computer terminal equipment in a computer terminal group. Alternatively, in the present embodiment, the computer terminal may also be replaced with terminal equipment such as a mobile terminal.

Alternatively, in the present embodiment, the computer terminal may locate in at least one of a plurality of network equipment of a computer network.

In the present embodiment, the computer terminal may execute program codes of the following steps in the thermodynamic diagram generating method: access data of identical display areas of a plurality of web pages is acquired, wherein the plurality of web pages are identical in page structure, and the identical display areas are areas having identical display content and identical display locations in the plurality of web pages; and the thermodynamic diagram of the identical display areas is generated according to the access data of the identical display areas of the plurality of web pages.

Alternatively, the computer terminal may include: one or more processors, memories and transmission devices.

Herein, the memory may be configured to store a software program and a module such as a program instruction/module corresponding to the thermodynamic diagram generating method and device in the embodiment of the present disclosure, and the processor executes various function applications and data processing by operating the software program and the module stored in the memory, namely implementing the above-mentioned thermodynamic diagram generating method. The memory may include a high-speed random access memory, and may further include a nonvolatile memory such as one or more magnetic storage devices, flash memories or other nonvolatile solid state memories. In some examples, the memory may further include memories remote from the processor, wherein these remote memories may be connected to a terminal via a network. The network examples include, but not limited to, internet, intranet, a local area network, a mobile communication network and combinations thereof.

The transmission device is configured to receive or transmit data via a network. The specific network examples may include a wired network and a wireless network. In an example, the transmission device includes a Network Interface Controller (NIC), which may be connected with other network equipment and routers via a network cable so as to communicate with the internet or local area network. In an example, the transmission device is a Radio Frequency (RF) module, configured to communicate with the internet wirelessly.

Herein, specifically, the memory is configured to store information about a preset action condition and users with preset permissions, and an application program.

The processor may retrieve the information and the application program stored in the memory via the transmission device, so as to execute program codes of the method steps in each alternative or preferred embodiment in the above-mentioned method embodiments.

Those of ordinary skill in the art may understand that the computer terminal may be terminal equipment such as a smart phone (Android phone, iOS phone or the like), a tablet computer, a palmtop, an MID, a PAD and so on.

Those of ordinary skill in the art may understand that all or some steps in various methods of the above-mentioned embodiments may be realized by instructing relevant hardware of terminal equipment via a program, the program may be stored in a computer-readable storage medium, and the storage medium may include: a flash disk, an ROM, an RAM, a magnetic disk or an optical disk.

The embodiment of the present disclosure also provides a storage medium. Alternatively, in the present embodiment, the storage medium may be configured to store program codes that could be executed for implementing the thermodynamic diagram generating method provided in the above-mentioned method embodiments and device embodiments.

Alternatively, in the present embodiment, the storage medium may be located in any one computer terminal in a computer terminal group in a computer network, or in any one mobile terminal in a mobile terminal group.

Alternatively, in the present embodiment, the storage medium is configured to store program codes for executing the following steps: access data of identical display areas of a plurality of web pages is acquired, wherein the plurality of web pages are identical in page structure, and the identical display areas are areas having identical display content and identical display locations in the plurality of web pages; and the thermodynamic diagram of the identical display areas is generated according to the access data of the identical display areas of the plurality of web pages.

Alternatively, in the present embodiment, the storage medium may also be configured to store program codes of various preferred or alternative method steps provided by the thermodynamic diagram generating method.

The thermodynamic diagram generating method and device according to the present disclosure are described as above by way of example with reference to the drawings. However, those skilled in the art should understand that various improvements may also be made on the thermodynamic diagram generating method and device provided in the present disclosure without departing from the content of the present disclosure. Therefore, the scope of protection of the present disclosure should be determined by the content of the appended claims.

The disclosure also provides a computer program product. When being executed on data processing equipment, the computer program product is suitable for executing program codes initializing the following method steps: access data of identical display areas of a plurality of web pages is acquired, wherein the plurality of web pages are identical in page structure, and the identical display areas are areas having identical display content and identical display locations in the plurality of web pages; and the thermodynamic diagram of the identical display areas is generated according to the access data of the identical display areas of the plurality of web pages.

The serial numbers of the embodiment of the disclosure are only used for descriptions, and do not represent the preference of the embodiments.

In the above-mentioned embodiment of the disclosure, descriptions for each embodiment are emphasized respectively, and parts which are not elaborated in a certain embodiment may refer to relevant descriptions for other embodiments.

In several embodiments provided by the disclosure, it will be appreciated that the disclosed device may be implemented in another way. For example, the device embodiment described above is only schematic. For example, division of the units is only logic function division, and other division ways may be adopted during practical implementation. For example, multiple units or components may be combined or integrated into another system, or some characteristics may be neglected or not executed. In addition, coupling or direct coupling or communication connection between the displayed or discussed components may be indirect coupling or communication connection, implemented through some interfaces, of the units or the modules, and may be electrical and mechanical or adopt other forms.

The above-mentioned units described as separate parts may or may not be physically separated, and parts displayed as units may or may not be physical units, and namely may be located in the same place, or may also be distributed to multiple network units. Part or all of the units may be selected to achieve the purpose of the solutions of the present embodiment according to a practical requirement.

In addition, each function unit in each embodiment of the disclosure may be integrated into a processing unit, each unit may also exist independently, and two or more than two units may also be integrated into a unit. The above-mentioned integrated unit may be implemented in a form of hardware, and may also be implemented in a form of software function unit.

When being implemented in a form of software function unit and sold or used as an independent product, the integrated unit may be stored in a computer-readable storage medium. Based on such understanding, the essence of the technical solution of the disclosure or parts making contributions to the related art or all or part of the technical solution may be embodied in a form of software product, and the computer software product is stored in a storage medium, including a plurality of instructions used to enable computer equipment (personal computer, server, network equipment or the like) to execute all or part of the method in each embodiment of the disclosure. The above-mentioned storage medium includes: various media capable of storing program codes such as a U disk, an ROM, an RAM, a mobile hard disk, a magnetic disk or an optical disk.

The above is only preferred implementation modes of the disclosure. It should be pointed out that those of ordinary skill in the art may also make some improvements and modifications without departing from the principle of the disclosure. These improvements and modifications should fall within the scope of protection of the disclosure.

1. A method for generating a thermodynamic diagram, comprising:
acquiring access data of identical display areas of a plurality of web pages, wherein the plurality of web pages are identical in page structure, and the identical display areas are areas having identical display content and identical display locations in the plurality of web pages; and
generating the thermodynamic diagram of the identical display areas according to the access data of the identical display areas of the plurality of web pages.

2. The method as claimed in claim 1, wherein acquiring the access data of the identical display areas of the plurality of web pages comprises:
acquiring a plurality of web pages having an identical preset quantity of directory hierarchy of a Uniform Resource Locator (URL);
acquiring access data of the plurality of web pages having the identical preset quantity of directory hierarchy of the URL; and
acquiring the access data of identical display areas of the plurality of web pages from the access data of the plurality of web pages.

3. The method as claimed in claim 2, wherein acquiring the access data of identical display areas of the plurality of web pages from the access data of the plurality of web pages comprises:
acquiring location information of the identical display areas of the plurality of web pages;
acquiring location information in the access data of the plurality of web pages; and
acquiring the access data of the identical display areas of the plurality of web pages from the access data of the plurality of web pages according to the location information of the identical display areas of the plurality of web pages and the location information in the access data of the plurality of web pages.

4. The method as claimed in claim 1, wherein generating the thermodynamic diagram of the identical display areas according to the access data of the identical display areas of the plurality of web pages comprises:
generating a snapshot of the identical display areas of the plurality of web pages; and
generating the thermodynamic diagram of the identical display areas on the snapshot according to the access data of the identical display areas of the plurality of web pages.

5. The method as claimed in claim 4, wherein the access data comprises at least one of following index parameters: a cursor event, a cursor hovering time and a cursor trajectory.

6. The method as claimed in claim 5, wherein generating the thermodynamic diagram of the identical display areas on the snapshot according to the access data of the identical display areas of the plurality of web pages comprises:
making statistics on an index parameter value of each area on the snapshot according to the access data of the identical display areas of the plurality of web pages; and
displaying the index parameter value of each area on the snapshot onto the each area of the snapshot according to a preset rule to obtain the thermodynamic diagram of the identical display areas.

7.-12. (canceled)

13. A computer terminal, executing program codes of steps provided by a method for generating a thermodynamic diagram as claimed in claim 1.

14. A storage medium, storing program codes executing a method for generating a thermodynamic diagram as claimed in claim 1.

15. The method as claimed in claim 2, wherein generating the thermodynamic diagram of the identical display areas according to the access data of the identical display areas of the plurality of web pages comprises:
generating a snapshot of the identical display areas of the plurality of web pages; and
generating the thermodynamic diagram of the identical display areas on the snapshot according to the access data of the identical display areas of the plurality of web pages.

16. The method as claimed in claim 3, wherein generating the thermodynamic diagram of the identical display areas according to the access data of the identical display areas of the plurality of web pages comprises:
generating a snapshot of the identical display areas of the plurality of web pages; and
generating the thermodynamic diagram of the identical display areas on the snapshot according to the access data of the identical display areas of the plurality of web pages.

17. The method as claimed in claim 15, wherein the access data comprises at least one of following index parameters: a cursor event, a cursor hovering time and a cursor trajectory.

18. The method as claimed in claim 16, wherein the access data comprises at least one of following index parameters: a cursor event, a cursor hovering time and a cursor trajectory.

19. The method as claimed in claim 17, wherein generating the thermodynamic diagram of the identical display areas on the snapshot according to the access data of the identical display areas of the plurality of web pages comprises:
making statistics on an index parameter value of each area on the snapshot according to the access data of the identical display areas of the plurality of web pages; and
displaying the index parameter value of each area on the snapshot onto the each area of the snapshot according to a preset rule to obtain the thermodynamic diagram of the identical display areas.

20. The method as claimed in claim 18, wherein generating the thermodynamic diagram of the identical display areas on the snapshot according to the access data of the identical display areas of the plurality of web pages comprises:
making statistics on an index parameter value of each area on the snapshot according to the access data of the identical display areas of the plurality of web pages; and
displaying the index parameter value of each area on the snapshot onto the each area of the snapshot according to a preset rule to obtain the thermodynamic diagram of the identical display areas.

21. A computer terminal, executing program codes of steps provided by a method for generating a thermodynamic diagram as claimed in claim 2.

22. A computer terminal, executing program codes of steps provided by a method for generating a thermodynamic diagram as claimed in claim 3.

23. A computer terminal, executing program codes of steps provided by a method for generating a thermodynamic diagram as claimed in claim 4.

24. A storage medium, storing program codes executing a method for generating a thermodynamic diagram as claimed in claim 2.

25. A storage medium, storing program codes executing a method for generating a thermodynamic diagram as claimed in claim 3.

26. A storage medium, storing program codes executing a method for generating a thermodynamic diagram as claimed in claim 4.
